(19) United States
(12) Patent Application Publication
(10) Pub. No.: US 2016/0377055 A1
(43) Pub. Date: Dec. 29, 2016

(54) Dual Cam Cylic Pitch Turbine

(71) Applicants: Jubilee Prasad Rao, Ewing, NJ (US); Francisco Javier Diez-Garias, Bridgewater, NJ (US)

(72) Inventors: Jubilee Prasad Rao, Ewing, NJ (US); Francisco Javier Diez-Garias, Bridgewater, NJ (US)

(73) Assignee: Rutgers, The State University of New Jersey, New Brunswick, NJ (US)

(21) Appl. No.: 15/187,479

(22) Filed: Jun. 20, 2016

Related U.S. Application Data
(60) Provisional application No. 62/183,980, filed on Jun. 24, 2015.

(51) Int. Cl. F03D 3/06; F03D 80/80; F03D 3/00; F03D 15/10; F03D 9/00; F03D 9/25

(52) U.S. Cl. CPC F03D 3/068; F03D 9/002; F03D 9/25; F03D 3/005; F03D 15/10; F03D 80/88

(57) ABSTRACT

This invention relates to a novel turbine design that increases turbine efficiency whereby turbine blades experience cyclic pitch variations while rotating about the blade axis which is accomplished by means of a concentric end cam double follower mechanism. This mechanism rotates the blades by 90 degrees about a horizontal axis which allows the blades rotating upstream and downstream to be oriented horizontally and vertically so minimum drag and maximum drag are obtained respectively. Since the aiding downstream drag is at a maximum, and the adverse upstream drag is at a minimum, this configuration allows for higher power output compared to conventional vertical axis wind turbines.

### CROSS REFERENCE TO RELATED APPLICATIONS

This application is entitled to the benefit of and incorporates by reference subject matter disclosed in Provisional Patent Application No. 62/183,980 tiled on Jun. 24,2015.

### FIELD OF THE INVENTION

This invention relates to a vertical axis wind turbine. More particularly, the invention relates to a vertical axis wind turbine with a dual cam cyclic pitch control.

### BACKGROUND OF THE INVENTION

Wind turbines have been in use tor many centuries to perform various tasks. But there has been an increased interest in them for power generation in the last decade because of factors like global warming and the need to shift to greener power generation methods. Many different wind turbine designs exist today. The major classification of wind turbines is based on the position of the axis of rotation of the blades with respect to the wind flow direction. Wind turbines with their axes parallel to the flow are called horizontal axis wind turbines (HAWT) and they occupy a majority of the present share of commercial wind turbines. Their blades' cross sections resemble an airfoil and produce lift and drag forces while wind blows over them. The lift forces generate torque and rotate the blades when wind velocity is sufficient.

Unlike HAWTs, vertical axis wind turbines (VAWT) have blades with the axis of rotation perpendicular to the wind direction. Hence, they are also called cross flow turbines. Popular VAWTs include the Darrius Turbine and the Savonius Turbine. Different Damns Turbine configurations exist and in most cases they are not self-starting. They use the lift forces on their airfoil blades to generate the required torque.

Savonius Turbines on the other hand are drag based turbines. Most of them have two buckets with an “S” shaped cross section and rotate about a symmetrical vertical axis. The shape of the turbine causes it to experience more drag in the down wind direction than that in the upwind direction and tits net drag forces the turbine to rotate. They are simple to construct, have cheaper maintenance and work independent of wind direction. The efficiency of these turbines drops very quickly with increase in rotational speed as it adversely alters the relative velocity between the wind and the buckets. Modifications to the Savonius turbine were made to minimize the upstream drag and increase efficiency which resulted in adverse inertial effects of moving parts at high speeds, in order to increase such a turbine's efficiency, it is necessary to maximize live aiding downstream drag and minimize the adverse upstream drag simultaneously.

A similar mechanism is found in a helicopter which uses a device called swash plate. It has two circular discs which can be tilted about any planar axis passing through their center. The lower disc only tilts while the upper disc also rotates along with the blades of the helicopter. The upper disc has levers connected to the blades through a crank. When these discs are tilted, one half on their surface is elevated while the other half is lowered. The levers on the elevated side of the discs move up rotating the crank which results in having an increased pitch on those blades while the blades on the lower side experience decreased pitch by the same amount. So each blade experiences a reversal of the pitch about a mean position when it moves from the elevated side to the lowered side i.e. for every 180 degrees of rotation in a cyclic manner. The blades with increased pitch produce more thrust than the blades with reduced pitch and this difference in thrust is the reason a helicopter can pitch forward or backwards and roll to the left or right according to the input from the pilot. And the maximum pitch angle attained by each of the blades m each cycle is proportional to the angle by which the discs are tilted. The swash plate can also be moved up or down without tilting which would change the collective pitch resulting in increasing or decreasing the altitude of the helicopter.

A swash plate converts linear input into rotary output which is the gradual continuous pitch variations spread uniformly over 360 degrees of rotation of a blade. But since, the turbine of the present invention benefits from quicker rotations which must happen when the blade is changing from upstream to downstream location and vice versa, an improved system is desired.

### SUMMARY OF THE INVENTION

In at least one embodiment, the present disclosure describes a dual cam pitch turbine assembly in which the turbine blades are rotated or pitched cyclically by means of a dual cam to obtain maximum differential drag between the drive stroke and the recovery stroke of the turbine cycle to maximize the efficiency and/or power output from a VAWT. This is analogous to the motion of an oar blade in the sport of shell rowing. The water is pushed backwards by an oar blade held perpendicular to the water surface during the drive stroke, and then the blade is rotated parallel to the water surface and pulled back to the initial position during the recovery. The drive stroke force and hence the work done is much larger during the recovery stroke, and net positive work is done on the system.

The system regains its initial state after completing one cycle. During this cycle, a small portion of work generated during the drive stroke is used to complete the recovery. Thus, the system can work independently and generate net positive work while capturing energy from the fluid flow.

In at least one embodiment, the present disclosure provides turbine blades that each rotate by 90 degrees twice in one cycle i.e. once each at the end of the drive stroke and then recovery stroke by means of a dual mechanical cam. The rotation can either be in the same direction or m the opposite as it would not have any effect on the resulting state. This is because rotating a blade by 90 degrees twice and rotating by 90 degrees in a certain direction and then rotating it back by 90 degrees results in a similar configuration.

In at least one embodiment, the present disclosure provides a dual cam combining two concentric end cams with a sharp rise and a sharp fall of the outer end cam aligned with a sharp fall and sharp rise respectively of the inner end cam. Followers which move over the end cams slide on the cams and rotate by 90 degrees whenever they move over the rise/fall of the end cams. The 90 degree rotation of the followers result in pitching motions of blades attached thereto. Where most mechanical cams convert input rotary motion of a shaft into a controlled linear or radial motion which can either be sudden or gradual based on requirements, linear cams convert linear motion into a modified still linear motion but in a direction perpendicular to the direction of initial motion. The dual cam of the present disclosure modifies the cam mechanism to output rotary motion from an input rotary motion.

In at least one embodiment, the present disclosure provides a dual cam cyclic pitch system with three turbine blades. Three blades are found to keep at least one blade in the drive stroke at all times, provides a compromise between simplicity and uniformity in power output However, it is understood that more or fewer blades may be utilized based on other design preferences.

In at least one embodiment the present disclosure provides for blade shapes as thin, rectangular plates. Though a rectangle may not be the optimal shape for the blades, rectangular plates are being used for simplicity and ease of analysis and comparison with other drag based VAWTs. However, the present disclosure recommends the use of a variety of known blade shapes including airfoils, variable pitch blades, oar shaped blades and the like.

The dual cam pitch turbine assembly disclosed herein is not limited to VAWT applications, or to tidal energy systems, but may be utilized in turbines of various applications such as wind turbines, propellers, and industrial turbines.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is a perspective view of a dual cam cyclical pitch turbine assembly in accordance with an embodiment of the present disclosure.

FIG. 2 is a perspective simplified partial view illustrating the dual cam and two of the follower mechanisms of FIG. 1.

FIG. 3 is a perspective view of a dual cam in accordance with an embodiment of the present disclosure.

FIG. 4 is a top plan view of a dual cam in accordance with an embodiment of the present disclosure.

FIG. 5 is a right side elevational view of a dual cam in accordance with an embodiment of the present disclosure, a left side elevational view being a mirror image thereof.

FIG. 6 is a from elevational view of a dual cam in accordance with an embodiment of the present disclosure.

FIG. 7 is a bottom plan, view of a dual cam in accordance with an embodiment of the present disclosure.

FIG. 8 is a perspective view of a dual cam cyclic pitch turbine assembly in accordance with a second embodiment of the present disclosure.

FIG. 9 is a cross sectional view of the dual cam cyclical pitch turbine assembly of FIG. 8 taken through line B-B.

FIG. 10 is an enlarged exploded view of turbine blade follower bearing assembly of FIG. 7.

FIG. 11 is an enlarged assembled view of the turbine blade follower bearing assembly of FIG. 7.

FIG. 12 is an enlarged exploded perfective view of a hub of FIG. 7.

FIG. 13 is an enlarged perspective view of a double connector of FIG. 7.

FIG. 13A is an enlarged cross sectional view of the double connector along the line A-A of FIG. 13.

FIG. 14 is an enlarged perspective view of a first follower part of FIG. 7.

FIG. 15 is an enlarged perspective view of a second follower part of FIG. 7.

### DETAILED DESCRIPTION OF THE INVENTION

In the drawings, like numerals indicate like elements throughout. Certain terminology is used herein for convenience only and is not to be taken as a limitation on the present invention. The following describes preferred embodiments of the present invention. However, it should be understood, based on this disclosure, that the invention is not limited by the preferred embodiments described herein, or to the particular systems, devices and methods described, as these can vary.

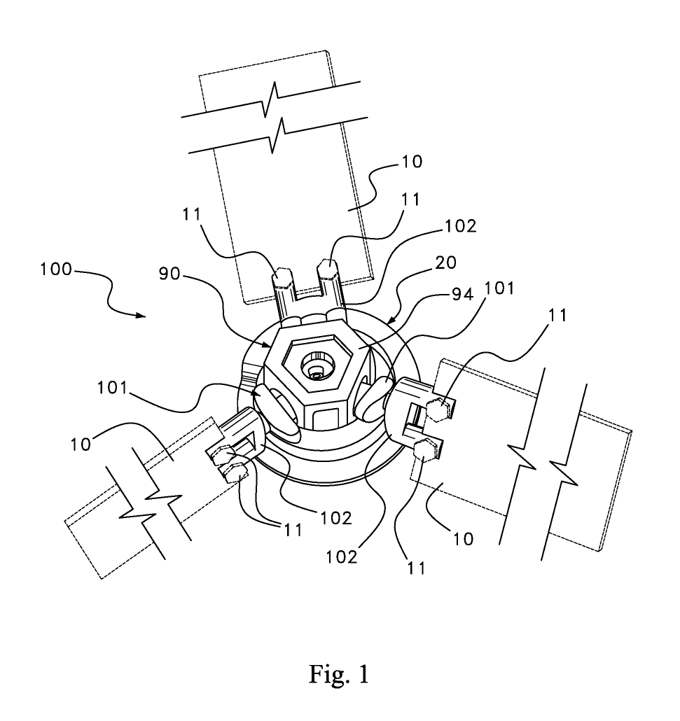

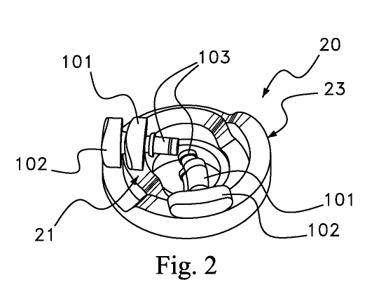

Referring to FIGS. 1-7, the present disclosure relates to a dual cam turbine blade assembly 100 in which a disk shaped dual cam 20 is configured with an inner cylindrical end cam 21 concentric to a cylindrical outer end cam 23 on an upper surface, and a bottom surface 18 that has an annular neck 19 for affixation to a drive shaft 98, The dual cam 20 is designed to interact with a moving follower shaft 103 so that under a fluid force the rotational interaction between the dual cam 20 and follower shaft 103 cause a turbine blade 10 affixed at one end of the follower shaft 103 to undergo a cyclical pitch motion by means of an inner lobe 101 and an outer lobe 102 which are located on the follower shaft 103 at locations that will interact with the inner cam 21 and outer cam 23 of the dual cam 20.

The inner cam 21 and the outer 23 cam of the dual cam 20 are uniformly molded, each having a lower surface area 26, 27 respectively, a raised surface area 28, 29 respectively, and a pair of sloping rises 22, 24 each respectively, rite inner and outer cams 21, 23 used in conjunction with the inner and outer lobes 101, 102 of a follower shaft 103 act as mechanical switches which are activated when a fluid flow moves the turbine blades 10, causing the inner and outer lobes 101, 102 to rotatingly interact with sloping rises 22, 24 of the inner and outer cams 21, 23, thereby changing the pitch of the turbine blades 10 with respect to the fluid by 90 degrees with each interaction. With continued movement of the follower shaft 103, the inner and outer lobes 101, 102 continue to interact with the sloping rises 22, 24, so that the turbine blades 10 undergo another rotation of 90 degrees back to their initial pitched profile positions. These changes in pitch occur in continuous cycles.

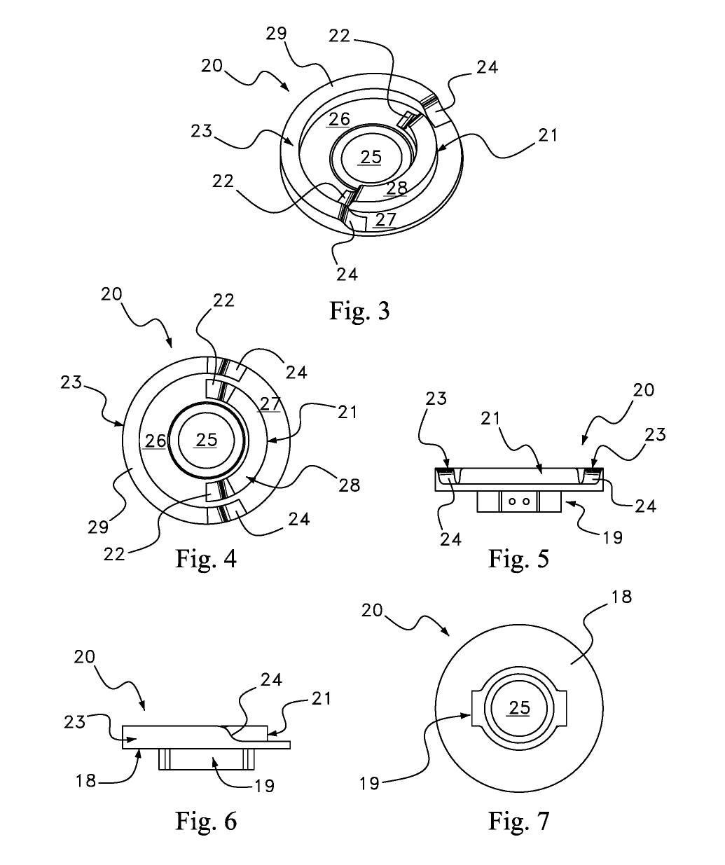

Referring to FIGS. 3-7. the position of the sloping rises 24 of the outer cam 23 with respect to the sloping rises 22 of the inner cam 21 of the dual cam 20 determines whether the inner and outer lobes 101, 102 of the follower shaft 103 rotate continuously in one direction or rotate back and forth in each successive pitching motion. The inner cam 21 is typically out of phase with respect to the outer cam 23 by 90 degrees, The sloping rises 22 of the inner cam 21 typically also coincide with the opposite sloping rises 24 of the outer cam 23, and vice versa which allows the inner and outer lobes 101, 102 to rotating roll without interference.

The dual cam 20 design allows for the inner and outer lobes 101, 102 of a follower shaft 103 to rotate twice in the same direction whenever the lobes move over one of the sloping rises 22, 24 of one of the inner or outer lobes 101, 102, which coincides the sloping rises 22, 24 of the opposing toner or outer cam 21, 23. The sloping rises 22, 24 are positioned such that they are typically 180 degrees apart but can be as little as 60 degrees apart. A turbine blade 10 connected to a follower shaft 103 rotates when the inner or outer lobe 101, 102 interacts with the sloping rise 22, 24 of the inner or outer cam 21, 23 respectively. The turbine blade 10 remains in the rotated position for the next 60 to 180 degrees of follower shaft 103 rotation and then again rotates by 90 degrees when the inner or outer lobe 101, 102 interacts with the opposite sloping rise 22, 24 of the inner or outer cam 21, 23 respectively, and then remains in that position for the next 60 to 180 degrees. The rotation of the turbine blades 10 is not abrupt, and is not preferred, as rotating the turbine blade 10 sharply might result in vibrations and might require more energy because the fluid around the turbine blade 10 would be displaced at a rate proportional to the speed of rotation of the follower shaft 103.

Still referring again to FIGS. 1-7, the inner and outer lobes 101, 102 are typically positioned out of phase with respect to each other by 180 degrees. The inner lobe 101 interacts with the inner cam 21. and the outer lobe 102 interacts with the outer cam 23 of the dual cam 20. While the inner lobe is active and is undergoing rotation over either of the sloping rises 22 or 24 of the inner cam 21, the outer lobe is passive and vice versa. And this happens alternatively for the pitching motion to be occur continuously. The inner and outer cams 21, 23 can be modified to obtain any number rotations of the follower shaft 103 by having the corresponding number of rises 22, 24 on the inner and outer cams 21, 23.

The turbine blade 10 is connected to the follower shaft 103 and rotates along with the follower shaft 103. The follower shaft 103 is connected to the dual cam turbine blade assembly 100 through a roller bearing to the hub 90 of the assembly 100 to which all the power is transferred. A drive shaft 98 is connected to the hub 90 and is concentric to the dual cam 20 and rotates through a roller bearing about a vertical axis whenever the turbine blades 10 rotate about the same axis.

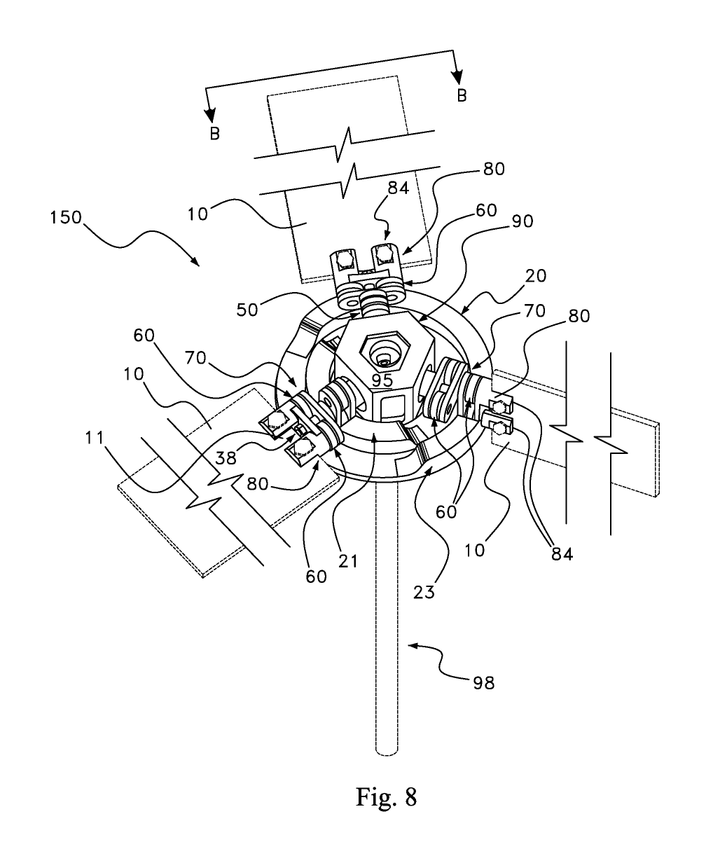

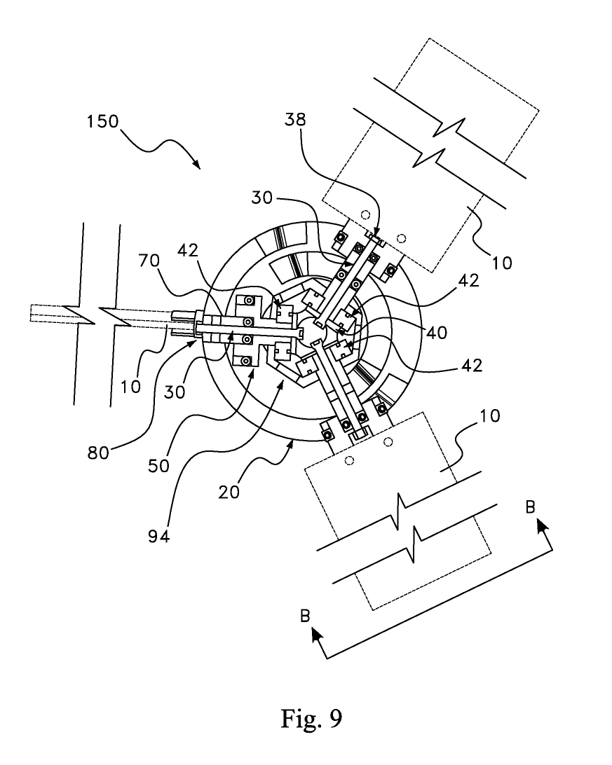

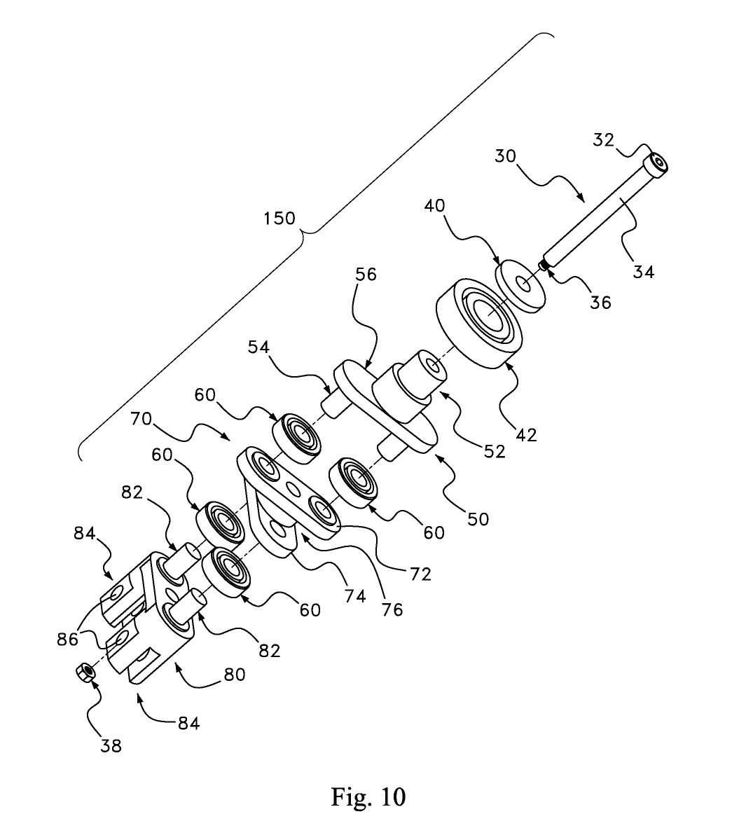

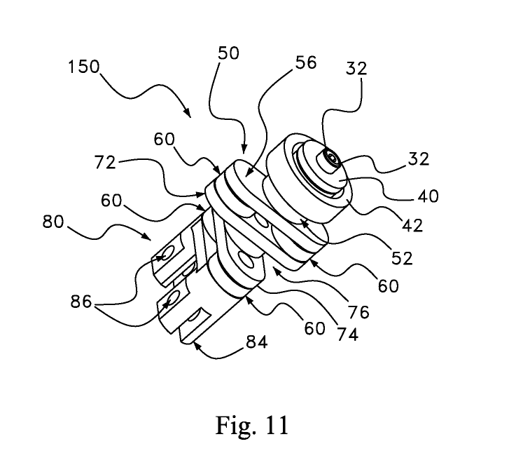

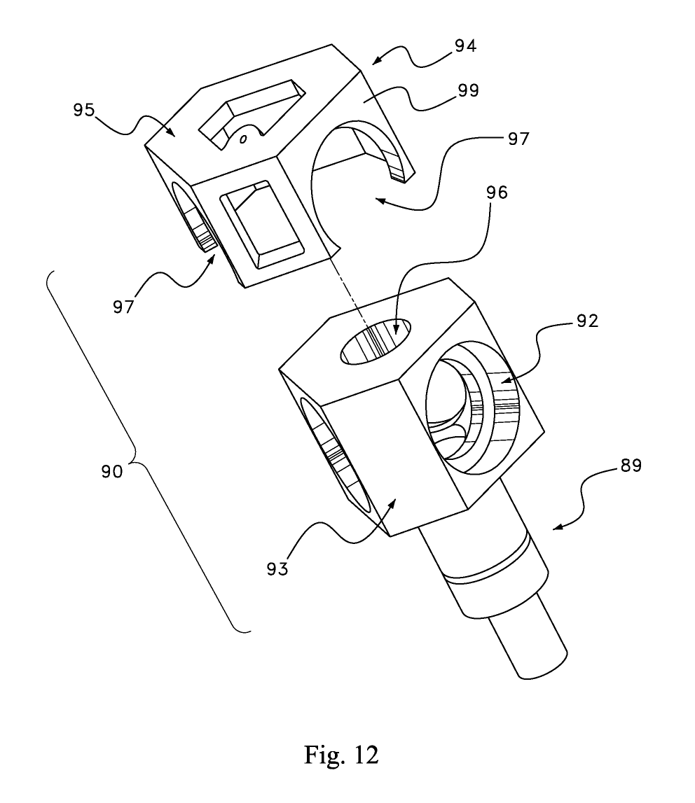

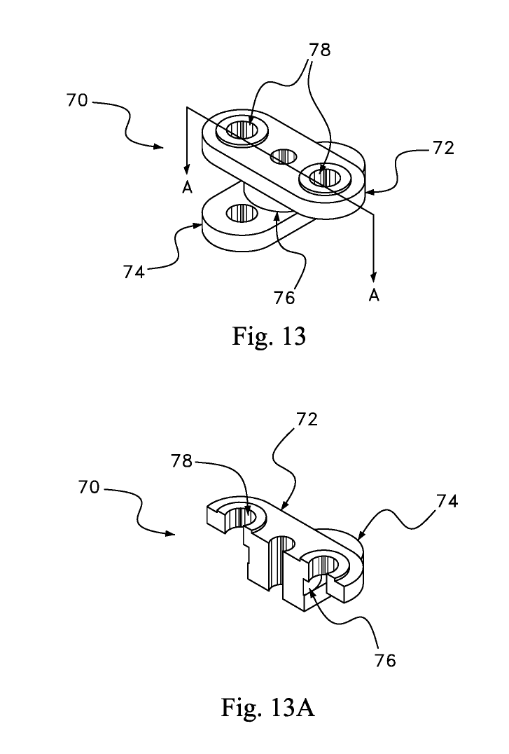

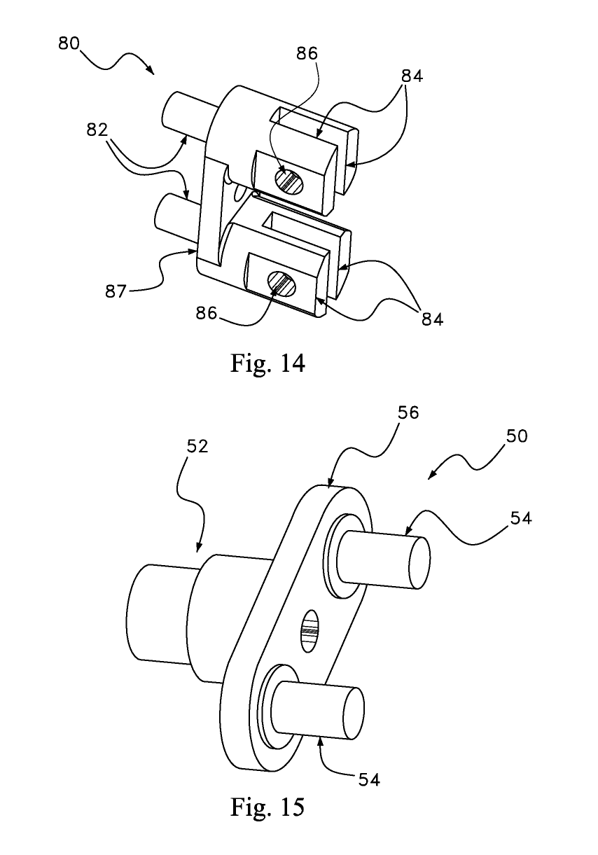

Referring now to FIGS. 8-16, a second embodiment of a dual cam turbine blade assembly 150 is disclosed. Each of a plurality of turbine blades 10 and followers 50 work in conjunction with the dual cam 20 to provide cyclical pitch to the turbine blades 10 upon interaction with fluid forces with reduced friction by incorporation of rotatable bearings, 60 of suitable material.

As shown in FIGS. 8-16, each follower 50 is comprised of a plurality of interlocking parts to form cam lobes which are fastened together by means of a bolt 30 whose bolt shaft 34 passes through the open centers of the plurality of parts starting at erne distal end and threadingly attaches with a threaded section 36 to a securing nut 38. The bolt head 32 is secured within a central hub 90 along with a washer 40 and a hub bearing 42, through which the bolt shaft 34 passes when the hub cover 94 cut outs 97 are snapped over and affixed to the hub apertures 92. The hub 90 is affixed at a lower distal end to a drive shaft 98. Extending outwardly from the hub 90, the bolt shaft 34 passes through the central openings of a first bearing lobe 50, a crisscross uniformly molded lobe connector 70, a second bearing lobe 80 and the nut 38. The adjacent affixation of the first bearing lobe 50, the crisscross lobe connector 70, and the second bearing lobe 80 form orthogonal parts that interact with the dual cam 20 to create the cyclic pitch motion of the turbine blade 10.

Lobe bearings 60 for the reduction of friction are secured within the follower 50 in compression by the bolt 30 and securing out 38 in between the first bearing lobe 50 find an upper surface 72 of the crisscross lobe connector 70, as well as in between the lower surface 74 of the crisscross lobe connector 70 and the second bearing lobe 80.

Still referring to FIGS. 8-16, the first bearing lobe 50 includes a flange 56, a neck extending outwardly front the flange 56 in a first direction, and a pair of first lobe pins 54, extending outwardly from the flange 56 in an opposite direction. The first lobe pins 54 are cylindrical and formed to pass through the cam bearing 60 then to rotatingly engage with annular holes 78 in an upper flange 72 of the crisscross lobe connector 70.

The second bearing lobe 80 has second lobe pins 82 at one end and turbine blade prongs 84 at an opposite end. The second lobe pins 82 are cylindrical and pass through bearing cams 60 then rotatingly engage with annular holes 78 in a lower flange 74 of the crisscross lobe connector 70 which is uniformly molded with a cylindrically shaped middle 76 connecting the upper flange 72 to the lower flange 74. The turbine blade prongs 84 each include a hole 86 for attaching a turbine blade 10 using a pair of standard nuts and bolts 11.

When comparing the invention herein with other drag based VAWTs, it is apparent that since the adverse drag force, which reduces the power output by a large amount, is considerably reduced it results in better efficiency.

These and other advantages of the present invention will be apparent to those skilled in the art from the foregoing specification. Accordingly, it will be recognized by those skilled in the art that changes or modifications may be made to the above-described embodiments without departing from the broad inventive concepts of the invention. It should therefore be understood that this invention is not limited to the particular embodiments described herein, but is intended to include ail changes and modifications that are within the scope and spirit of the invention as defined in the claims.

What we claim is:

1. A rotary fluid turbine cam assembly comprising:
a disk shaped earn having a bottom surface, and a top surface, the top surface including a plurality of semi-annular cams;
and a plurality of cam followers, each of said plurality of cam followers having an elongated shaft tor attachment to a turbine blade at a first distal end, and a plurality of rotatable lobes located adjacent to each other and proximate to said turbine blade, wherein the plurality of rotatable lobes is configured for interaction with the plurality of semi-annular cams to rotate said turbine blade about a longitudinal turbine blade axis to create a cyclical pitch motion of said turbine blade under a fluid flow to achieve a drive stroke and a recovery stroke in one complete rotation around said disk shaped cam;
and wherein during the drive stroke, a surface area of said turbine blade is substantially orthogonal to a direction of said fluid flow, and during said recovery stroke a surface area of the turbine blade is substantially parallel to the direction of the fluid flow.

2. The rotary fluid turbine cam assembly according to claim 1 including an annular opening in the center of said disk shaped cam for attachment to a drive shaft.

3. The rotary fluid turbine cam assembly according to claim 1 wherein the plurality of semi-annular cams are formed concentrically and out of phase with each other.

4. The rotary fluid turbine cam assembly according to claim 1 wherein the turbine blade is a flat plate.

5. The rotary fluid turbine earn assembly according to claim 1 wherein the turbine blade is and airfoil in cross section.

6. The rotary fluid turbine cam assembly according to claim 1 wherein the turbine blade rotates in an oblong orbit.

7. The rotary fluid turbine cam assembly according to claim 1 wherein the turbine blade Is a flexible membrane which flexes during operation.

8. The rotary fluid turbine cam assembly according to claim 1 wherein the turbine blade rotates in an elliptical orbit.

9. The rotary fluid turbine cam assembly according to claim 1 wherein the turbine blade attaches to one of the plurality of cam followers by at least one turbine bolt and one turbine nut.

10. The rotary fluid turbine cam assembly according to claim 1 including a hub having u central housing and a turbine rotor shaft extending downwardly therefrom, wherein each of said plurality of said cam followers is affixed within said central housing to rotate said turbine rotor shaft.

10. The rotary fluid turbine cam assembly according to claim 9 wherein each of said plurality of said cam followers affixes within the central housing of the hub by means of a bolt.

11. A dual cam for a turbine blade assembly comprising
a uniformly molded disk having a bottom surface, a top surface, and an annular hole in the center of the uniformly molded disk, the top surface including a plurality of end cams, each of said plurality of end cams having a lower cam surface, and a upper cam surface extending upwardly from said top surface, with a cam rise connecting the lower cam surface to the upper cam surface at one end of the upper cam surface, and a cam fall connecting a second end of the upper cam surface to the lower cam surface.
